(19) United States
(12) Patent Application Publication
(10) Pub. No.: US 2016/0279590 A1
(43) Pub. Date: Sep. 29, 2016

(54) DISPENSING DEVICE AND METHOD

(71) Applicant: GINOLIS OY, Oulunsalo (FI)

(72) Inventor: Per Ove ÖHMAN, Uppsala (SE)

(21) Appl. No.: 14/669,399

(22) Filed: Mar. 26, 2015

(51) Int. Cl. B01J 19/00

(52) U.S. Cl. CPC B01J 19/0046; B01J 2219/00351; B01J 2219/00585

(57) ABSTRACT

A system is provided for dispensing a plurality of droplets substantially simultaneously onto a substrate (51). The liquids are stored in wells in a manifold plate (1) and transferred via micro capillaries to a transfer block (31). The transfer block comprises capillary through channels (33) which lead to outlets (41). The transfer block can be moved so that outlets can be brought into contact with the surface of the substrate and capillary action between the outlets and the surface of the substrate will cause a droplet of liquid to be loaded from each outlet onto the surface.

### FIELD OF THE INVENTION

The invention relates to systems, methods, kits and devices for transferring a liquid or liquids from one or more reservoirs and for dispensing the liquid or liquids as droplets.

### BACKGROUND OF THE INVENTION

In many diagnostic testing systems an array formed of spots of different reagents is provided on a usually flat solid substrate and a liquid sample containing substances which need to be identified or quantified is applied to the array. After a suitable time has lapsed for any reactions to take place the substrate is examined in order to ascertain which, if any, of the reagents has reacted with the sample.

The reagents are often expensive and in order to keep the costs per test low it is important to minimise the size of each spot in the array as small as possible. Typically an array will comprise tens or hundreds of spots, each comprising a different reagent, in an area of several square centimetres or less. The spots are formed by depositing onto a substrate drops of a liquid containing one or more reagents and allowing the liquid to evaporate. One problem in manufacturing such arrays is how to dispense tens or hundreds of drops of reagents precisely (i.e. with a predetermined volume) and accurately (to a predetermined position) in a short time. One way of doing this is to use piezo-activated spotting of pico-litre sized droplets. In prior art devices every reagent needs a unique dispensing channel and every channel requires valves, pumps, dispensing lines, dispensing actuators, nozzles, and cleaning mechanisms between reagents. A dispensing channel needs to be set up for each of the tens or hundreds of reagents and the failure of one reagent dispensing channel will result in an unusable product which must be scrapped.

### BRIEF DESCRIPTION OF THE INVENTION

A system in accordance with the present invention for precisely dispensing small volumes of liquid into a predetermined pattern on a substrate comprises one or more liquid reservoirs in a manifold plate, a transfer block for collecting small volumes of liquid from the manifold plate and transfer means for moving the transfer block to a position where the small volumes of liquid can be dispensed onto a substrate. Preferably the manifold plate is a solid substrate with the same outer dimensions and shape as the standard 384 micro titre well plate that is well-known in the art as this allows compatibility with prior art well plate handling equipment. Preferably the first, e.g., the top, major surface of the manifold plate comprises an array of a plurality N of reservoirs in the form of wells, e.g. 384 wells in a 24×16 array. Each well descends from the top surface of the manifold plate towards the second, e.g. the bottom, major surface of the manifold plate. The base of each well is connected by a micro capillary which opens out on the second major surface in a micro array of N outlet ports, preferably arranged in a layout which mirrors that of the reservoirs, e.g. a 24×16 array. Preferably the centre-to-centre (C-C) distance of the outlet ports of the micro array is less than 1 mm and more preferably is less than 500 μm—which could give an outlet port density of 400 openings/cm². The liquid from each reservoir is automatically fed to its respective outlet port in the ordered array underneath the manifold plate by capillary force. The outlet ports are adapted by means of their structure and/or differences in surface energy between the liquid and the material of which the substrate is made to create a meniscus of the liquid. Preferably the meniscus is convex.

The transfer block comprises a preferably thin substrate, for example 0.1 mm to 2 cm thick, with a plurality of capillary through channels which extend from inlet openings in the first, upper, major surface to outlet openings in the second, lower, major surface. The through channels are arranged in a pattern. The position and spacing of the through channels match that of the outlet ports of the micro array in the manifold block. The transfer block can be moved by the transfer means to a position under the manifold plate in which the inlet openings of the through channels are aligned with the outlet ports in the manifold plate. The inlet openings of the capillary through channels can then be brought into contact with the meniscuses of the manifold plate. Capillary action will cause liquid from the manifold plate outlet ports to be transferred to, and substantially fill, the capillary through channels in the transfer block. In this way a known volume (corresponding substantially to the volume of each through channel plus the volume of any convex meniscus and minus the volume of any concave meniscus) of liquid (e.g. a solution containing a reagent) can be transported from the outlet port of every reservoir in the manifold plate to the transfer block. The outlet openings of the transfer block will have a meniscus of the liquid. Preferably the outlet openings are adapted, by means of their structure and/or differences in surface energy between the liquid and the material of which the substrate is made, to create a convex meniscus of the liquid.

The system can be used to substantially simultaneously dispense precisely controlled quantities of the liquid(s) to a substrate. The substrate could be formed of any material to which the liquids can be attached, for example, a slide. Such a slide may, for example, be the carrier of reagents that will be used in a diagnostic test. A slide may be a moulded plastic chip. The substrate preferably is provided with surface features such as projections or depressions which facilitate the formation of the arrays of dispensed liquid and/or ensure that the dispensed liquid flows to the intended position and/or stays in the intended position. Alternatively or in addition to surface features a slide may be subjected to surface treatments or coatings which may some areas more hydrophilic or hydrophobic than others in order to ensure that the dispensed liquid stays in the intended position. Any surface features and/or surface treated treatments or coatings are arranged in an array with a pattern and spacing which matches that of the outlet openings in the transfer block in order to ensure that dispensed drops are correctly positioned. If the slide is for use in a diagnostic test then it may be covered with a surface coating that provide effective coupling of the reagents, for example antigens/antibodies, of choice, as well as providing with an inert surface minimizing non-specific binding.

The design of the slide may be chosen to provide optimal properties for the detection system of choice, e.g. it may be transparent if the detection system uses fluorescence and the fluorescence is to be detected through the slide. If the fluorescence is to be detected from the side of the slide on which the surface features are present then it may be advantageous to provide the slide with a dark or black absorbing coating or made the slide from a dark or black coloured material which will reduce the effects of self-fluorescence from the material of the slide.

The liquid in the transfer block can be transferred to a slide by the outlet openings of the transfer block by bringing the meniscuses of liquid in the outlet openings briefly into contact with the respective surface features of the slide. The surface features are adapted so that the force which attracts liquid from the meniscus to the surface feature is greater than that which holds the liquid in the meniscus and this enables some of the liquid from the meniscus to be transferred to the surface. Once a predetermined time which is equal to or greater than the time necessary to transfer the desired amount of liquid to each surface feature has elapsed the contact of the transfer block with the surface features is broken, leaving droplets of liquid on the substrate. A new slide, or a new portion of the slide, is then contacted by the transfer block. This is continued until a predetermined proportion of the original volume of liquid in the transfer block has been transferred. This predetermined proportion is preferably less than 100% of the original volume of liquid in order to ensure that no capillary through channel runs dry, as if this were to occur then the substrate would not receive a full loading of droplets and may thereby be unusable.

The depleted transfer block may then be brought into contact with the manifold plate and the capillaries refilled ready for the next substrate contacting operation.

### BRIEF DESCRIPTION OF THE DRAWING

FIG. 1a) shows schematically a plan view from above of a manifold plate in accordance with a first embodiment of the present invention.

FIG. 1b) shows schematically a side view of the manifold plate of FIG. 1a).

FIG. 1c) shows schematically another side view of the manifold plate of FIG. 1a).

FIG. 1d) shows schematically a plan view from below of the manifold plate of figure la).

FIG. 1e) shows schematically a plan view of an embodiment of a transfer block for use with the manifold plate of FIGS. 1a) to 1d).

FIG. 1f) shows schematically a plan view of an embodiment of a liquid-receiving substrate for use with the transfer block of FIG. 1e).

FIG. 2a) shows schematically an enlarged plan view of the transfer block of FIG. 1e).

FIG. 2b) shows schematically a section along line B-B of FIG. 2a).

FIG. 2c) shows schematically an enlargement of the marked portion of FIG. 2a).

FIG. 2d) shows schematically a cross-section through a second embodiment of a transfer block in accordance to the present invention.

FIG. 2e) shows schematically an enlargement of a plan view of two capillary through channels of the transfer block of FIG. 2d).

FIG. 2f) shows schematically a cross-section through a further embodiment of a transfer block in accordance to the present invention.

FIG. 2g) shows schematically an enlargement of a plan view of above of two capillary through channels of the transfer block of FIG. 2f).

FIG. 3a) shows schematically an enlarged plan view of the liquid-receiving substrate of figure lf).

FIG. 3b) shows schematically a section through line C-C of FIG. 3a).

FIG. 3c) shows an enlarged plan view of a liquid receiving area of the slide of FIG. 3a).

FIG. 3d) shows an enlarged plan view of a second embodiment of a liquid receiving area of a slide.

FIG. 3e) shows an enlarged plan view of a further embodiment of a liquid receiving area of a slide.

FIG. 4 shows a section through line A-A of the manifold plate of figure la), the section through line B-B of the transfer block of FIG. 2a) and the section through line C-C of the slide of FIG. 3a).

FIG. 5 shows schematically in perspective a further embodiment of a manifold plate, a further embodiment of a transfer block and a further embodiment of a liquid-receiving substrate.

FIG. 6 shows a perspective exploded view of the manifold plate of FIG. 5.

FIG. 7 shows a magnified section of the manifold plate of FIG. 5.

FIG. 8 shows a further magnified section view of the manifold plate of FIG. 5.

FIG. 9 shows a schematic section in perspective through the manifold plate and transfer block of FIG. 5.

FIG. 10 shows schematically in perspective the transfer block of FIG. 5.

FIG. 11 shows schematically in perspective a section through an empty transfer block of the type shown in FIG. 5.

FIG. 12 shows schematically in perspective a section through a filled transfer block of the type shown in FIG. 5.

FIG. 13 shows an enlarged view of the portion in the dashed box of FIG. 12.

FIG. 14 shows schematically in perspective part of the liquid-receiving substrate of FIG. 5.

FIG. 15 shows schematically in perspective a section through a full transfer block and a non-contacted array on a liquid-receiving substrate of the type shown in FIG. 5.

FIG. 16 shows schematically an enlarged view in section of the exhausted transfer block of FIG. 15 and the contacted array on the liquid-receiving substrate shown in FIG. 15.

FIG. 17 shows schematically in perspective the contacted array and the transfer block of FIG. 16.

FIG. 18 shows schematically a first embodiment of a dispensing system in accordance with the present invention.

FIG. 19 shows schematically a second embodiment of a dispensing system in accordance with the present invention.

### DETAILED DESCRIPTION OF THE INVENTION

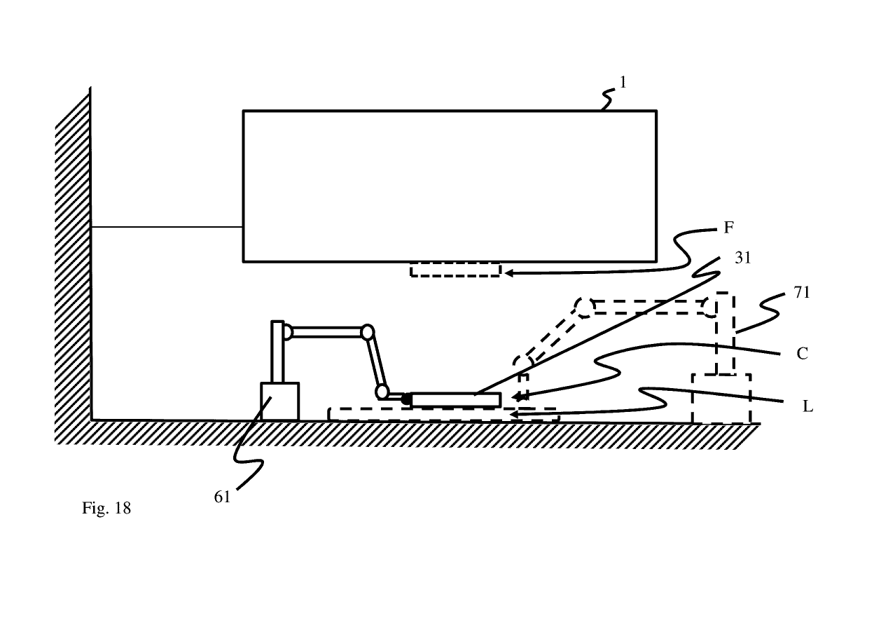

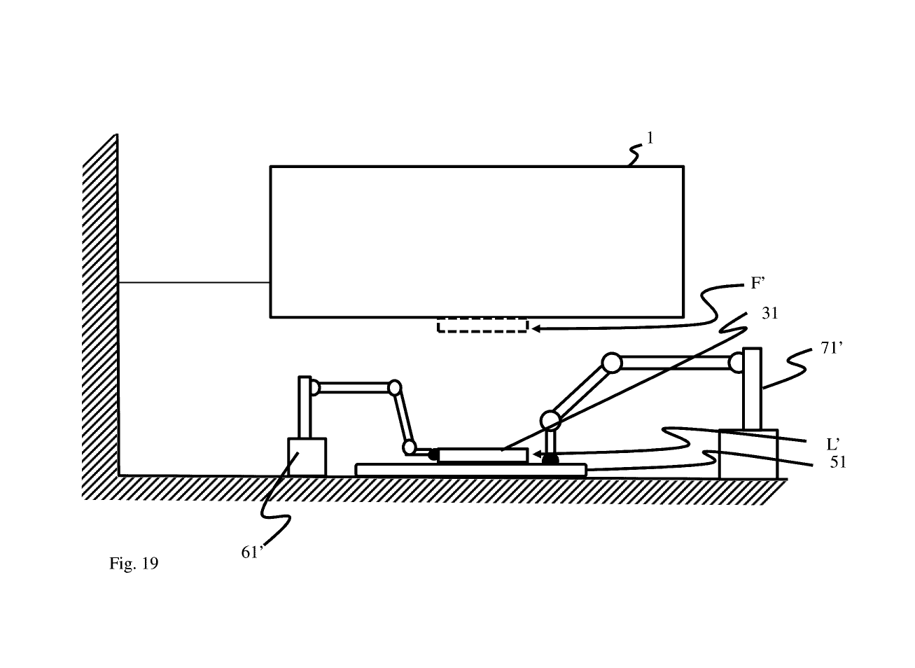

An embodiment of a dispensing system in accordance with the present invention for dispensing drops on a substrate such as a slide (51) comprises a manifold plate (1) and a transfer block (31) and is shown schematically in FIG. 18. The manifold plate (1) comprises a substantially quadratic substrate (3) with a filing surface, preferably the upper major surface (5) and a dispensing surface which is preferably the lower major surface (7). The upper and lower major surfaces are separated by side walls (9) of height H1. In this embodiment of a manifold plate the shape, the length L1, width W1 and height H1 of the substrate are the same as, or within 10% of, those of the well-known standard 384 micro well plate i.e. 127.8×85.5×14.2 mm, but any other shape and size may be used. As shown in FIG. 4, the upper surface has a plurality N (e.g. N=384) of reservoirs in the form of wells (11) which extend a distance d into the substrate where d<H1 (for example, when H1 is 14.2 mm then d is less than or equal to 12 mm) towards the lower major surface. The wells are shown arranged in a regular 24 well×16 well array but any shape of array is possible. Each well is openable on the filing surface in order to allow each well to be filled with an individual liquid (13) such as a reagent. Each liquid may be different from all other liquids or some or all of the liquids may be duplicated. Providing duplicate wells of liquids allows a degree of redundancy to the system and means that in the event of one well being defective the resulting slide may still be useful. As shown here by a dashed line, it is possible to provide the manifold plate with a cover (15) in order to reduce or eliminate evaporation of liquids. The base (17) of each well comprises a respective capillary (19), i.e. a channel with a small cross-sectional area which can be filled by liquid under the influence of capillary forces, which leads to a open capillary outlet (21) on the dispensing surface of the manifold plate. This dispensing major surface is preferably the lower major surface of the manifold plate. Each capillary can have a substantially constant cross-sectional area or the cross-sectional area can vary along the length of a capillary, for example it may taper from the bottom of the well down so that it becomes smaller as it progresses towards the capillary outlet as shown in FIG. 4a). The capillary has an average diameter D1 which preferably is equal or greater than 10 μm and is equal to or less than 100 μm. Preferably the substrate is made of an injection-mouldable polymer such as a cyclic oleo polymer or polystyrene. Preferably each outlet has a diameter D2 which preferably is equal or greater than 10 μm and is equal to or less than 100 μm. The 384 capillary outlets (21) are arranged in a dispensing array (23) which in this example of the invention matches, but is much smaller than, that of the wells, i.e.it is an array of 24 by 16 outlets. Other quadratic arrays formats are of course possible, for example, 12 by 32 or 6×64, etc. It is also possible that the array forms any other shape, for example a ring, a circle, a hexagon, a triangle, etc. In this example the quadratic dispensing array has a length L2 and width W2. Preferably the centre-to-centre (C-C) distance of the outlet ports of the micro array is equal to or less than 1 mm and more preferably is equal to or less than 500 μm and equal to or greater than 50 μm. The grid of 384 outlets may thus have an area equal to or less than 2 square centimetres.

When a well is supplied with a liquid such as a reagent the capillary force in the capillary will cause the reagent to flow through the capillary at the base of the well.

Preferably the surface properties of the outlet are adapted to the reagent so that the reagent forms a convex meniscus M1 at the outlet of the capillary. Preferably the areas of the lower surface situated between the capillary outlets may be made hydrophobic to reduce the chance of cross-contamination.

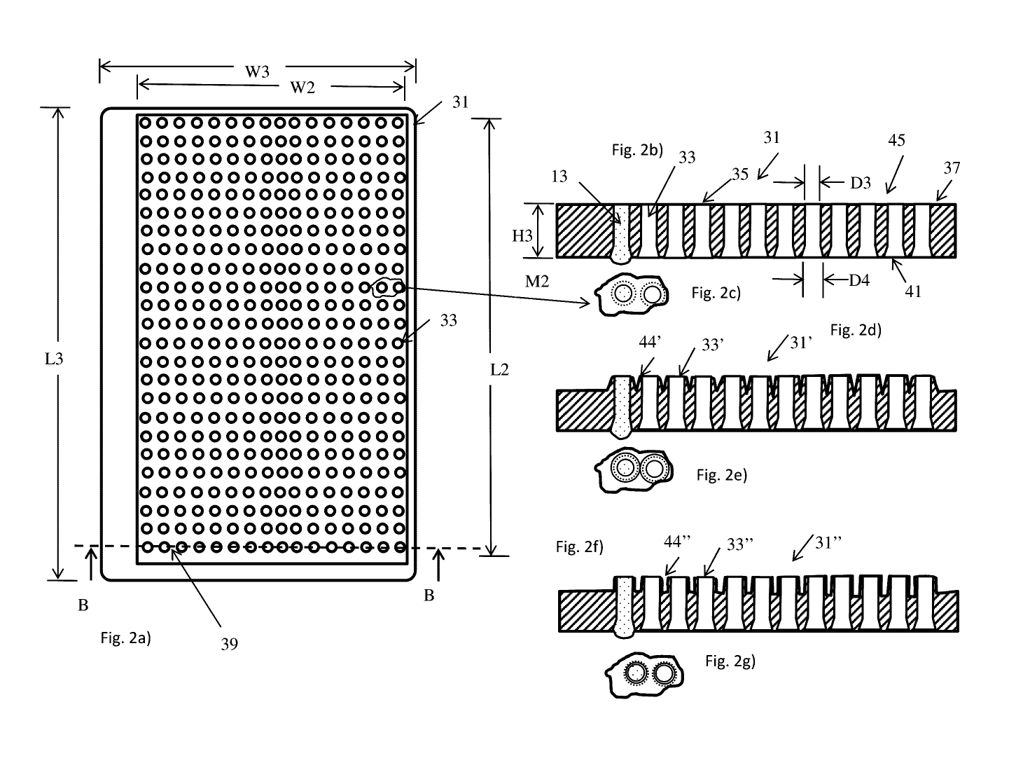

As illustrated in FIGS. 2a) to 2c) an embodiment of a transfer block (31) comprises a thin substrate of height H3, length L3 and width W3 where L3 is greater than L2 and W3 is greater than W2. H3 is preferably equal to or greater than 0.1 mm and equal to or less than 2 cm, more preferably equal to or greater than 0.5 mm and equal to or less than 15 mm, and even more preferably equal to or greater than 2 mm and equal to or less than 10 mm. Preferably the substrate is made of a polymer or other material which can be moulded with high precision for example the same material as used for the manifold plate. The transfer block comprises a number of capillary through channels which correspond to the number of capillaries on the manifold plate i.e. in this example, 384 capillary through channels (33). Each capillary through channel has a diameter D3 which preferably is equal or greater than 10 μm and is equal to or less than 100 μm. The inlets (35) to each capillary through channel formed in a liquid receiving major surface, for example the upper major surface (37), of the transfer block are laid out in an inlet array (39) which matches the dimensions and layout of the array of capillary through channel outlets on the manifold plate, i.e. the width of the inlet array is W2 and the length of inlet array is L2, and the inlets (35) are positioned so that each outlet on the manifold plate can be contacted with a corresponding capillary inlet on the transfer block. Preferably the longitudinal axis of the capillary through channels (33) are parallel to each other and the outlets (41) of the capillary through channels form an outlet array (43) on the liquid dispersing surface, for example the lower major surface (44) of the transfer block. Preferably the outlet array is of similar size and shape as the inlet array (39) of the capillary through channels, however it is conceivable that the longitudinal axis of the capillary through channels are not arranged in parallel and the outlets (41) of the capillary through channels form an outlet array with a different shape to that of the inlet array (39). The diameters D4 of the outlets (41) may have an outlet diameter which is greater than that of the capillary through channel immediately before the opening in order to facilitate the formation of large drops. In such cases the diameter D4 may be, for example, equal to or greater than twice D3.

Furthermore, while the liquid receiving surface and liquid dispensing surfaces have been shown to be on opposite sides of the transfer block it is conceivable that they are on the same side of the transfer block or on orthogonally arranged sides of the transfer block.

FIGS. 2d) and 2e) show a second embodiment of a transfer block in accordance with the present invention. This transfer block (31′) comprises surface features which reduce the risk of cross-contamination between adjacent capillary through channels (33′) when they are being loaded. These surface features consist of V-shaped grooves (44′) which surround each inlet (35). The valleys of these grooves provide space for excess liquid from one inlet to accumulate without contaminating any other inlet.

FIGS. 2f) and 2g) show a further embodiment of a transfer block in accordance with the present invention. This transfer block (31′) comprises surface features which reduce the risk of cross-contamination between adjacent capillary through channels (33″) when they are being loaded. These surface features consist of grooves (44″) with a U-section which surround each inlet (35). The valleys formed by the base of the U-shape of these grooves provide space for excess liquid from one inlet to accumulate without contaminating any other inlet.

In order to load a transfer block with reagents, the transfer block is positioned below and in alignment with the dispensing array of capillary through channel outlets in the lower surface of the manifold plate. When the transfer block is raised or in some other way positioned into contact with the underside of the manifold plate, each capillary through channel in the liquid inlet surface (45), normally the upper surface, of the transfer block will come into contact with the meniscus above it and capillary force will cause the liquid (13) to flow into the capillary through channel and form a convex meniscus M2 on the outlet (37) of the capillary through channel on the liquid dispensing surface (47), normally the lower surface, of the transfer block. The reagent will continue to flow into the capillary through channel until the capillary through channel is full or contact between the capillary through channel and the outlet on the manifold plate is broken.

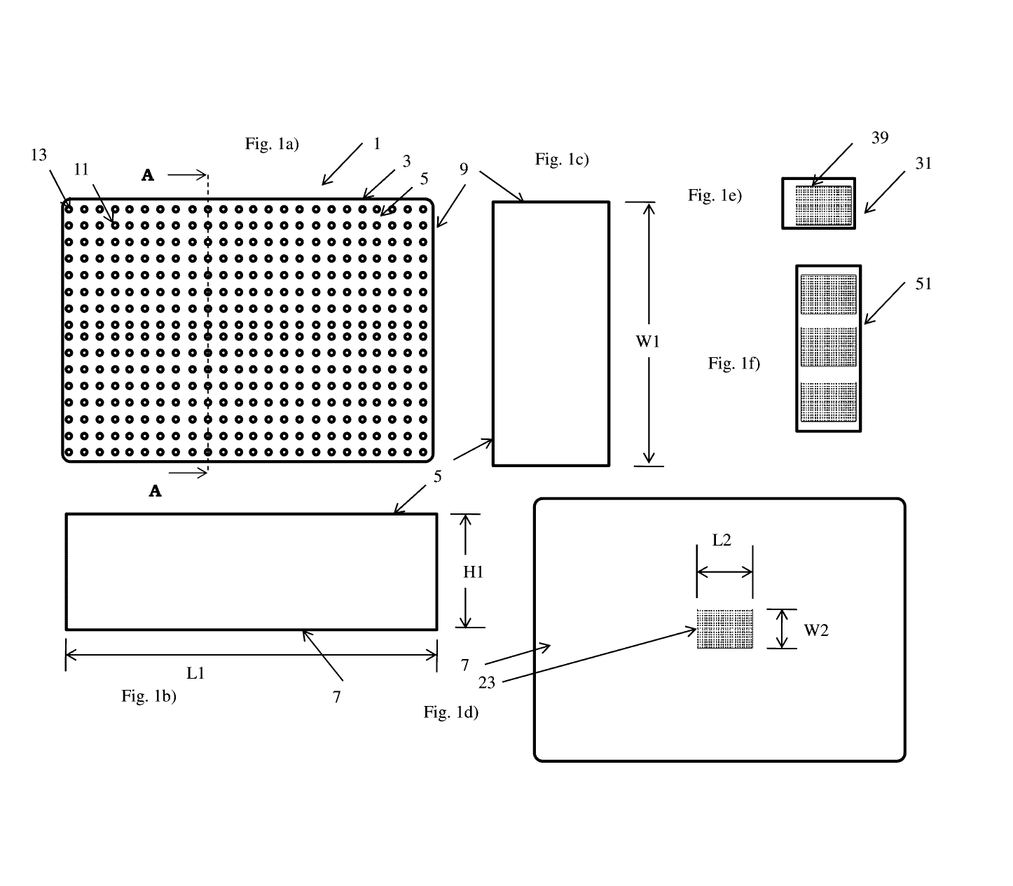

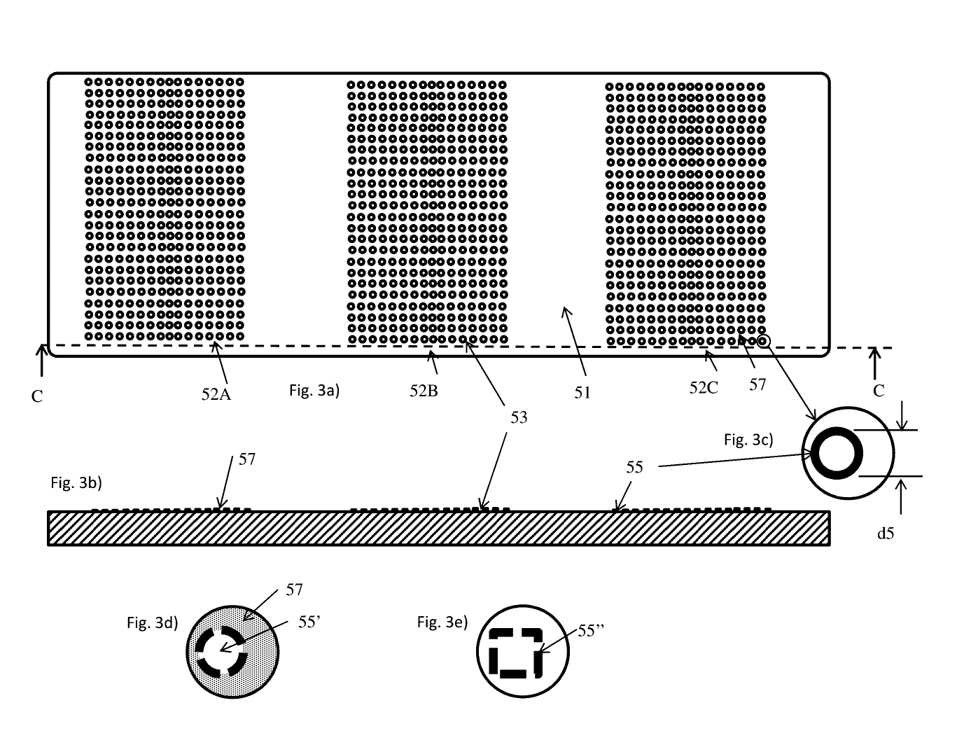

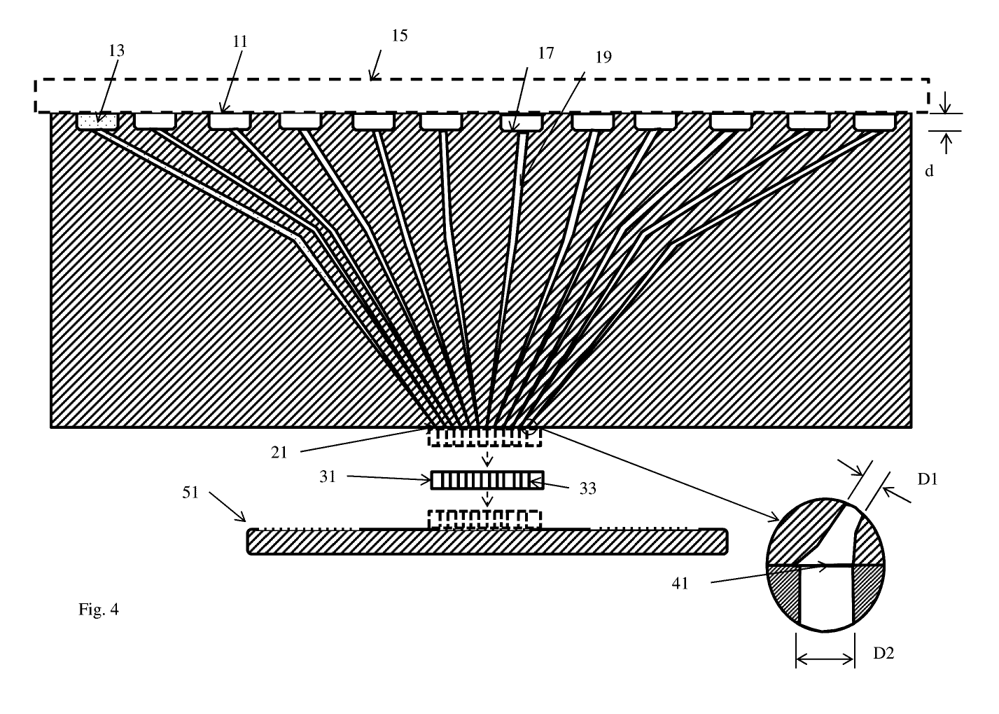

A liquid-receiving substrate may be of any suitable shape and size. In its simplest form it may be a plane substrate with no special features which promote or facilitate the positioning and capture of drops of liquid. However as the liquids which are intended to be deposited on the substrate are expensive it is preferable that a liquid-receiving substrate is provided with features which prevent the liquid being wasted, for example features which help retain the liquid in a desired position. As an illustrative example FIGS. 1, 3 and 4 show a quadratic liquid-receiving substrate in the form of a slide (51) able to accommodate three liquid-receiving arrays LRA1, LRA2 and LRA3, each of width W2 and length L2. Each liquid receiving array LRA1-LRA3 comprises 384 liquid-receiving areas (53) laid out in an array of the same shape and size as the outlet array (43) on the liquid dispensing surface (47) of the transfer block. Preferably each liquid-receiving area intended to receive a liquid such as a reagent in aqueous solution is provided with an anchoring surface feature (55) which helps to anchor into place any liquid which comes into contact with it. An anchoring surface feature (55) may be a raised circular wall as shown in FIG. 3c), a projection such as a dome, a series of projections, for example a ring of projections (55′) as shown in FIG. 3d) or a square of projections (55″) as shown in FIG. 3e), or the like, or the anchoring surface feature could be a depression or the like. Each liquid-receiving area may also be provided with a hydrophobic surface, surface treatment or coating (57) between the anchoring surface features to ensure that aqueous liquids do not rest there. Preferably the diameter D5 of each anchoring surface feature is equal to or less than the outlet diameter D4 of the corresponding outlet in the transfer block.

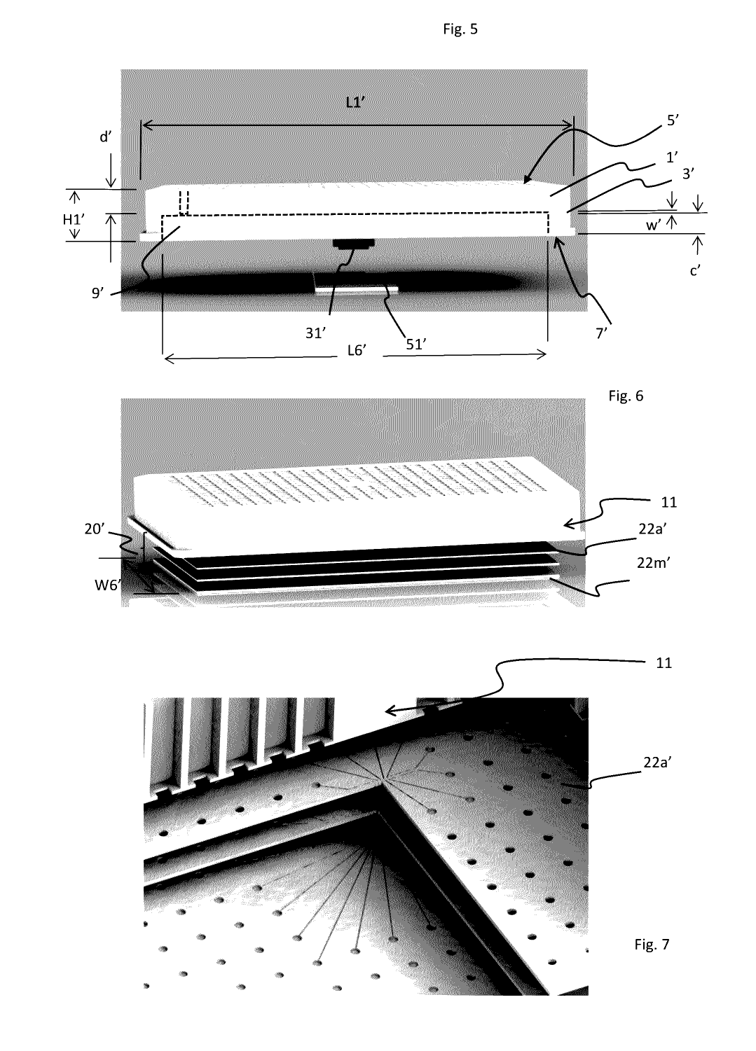

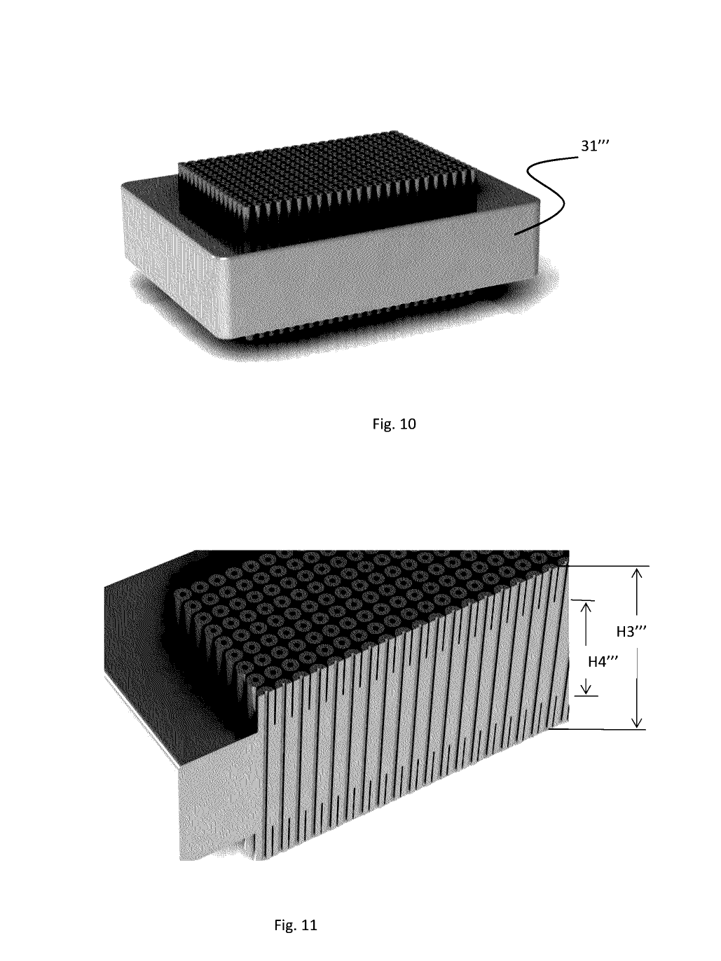

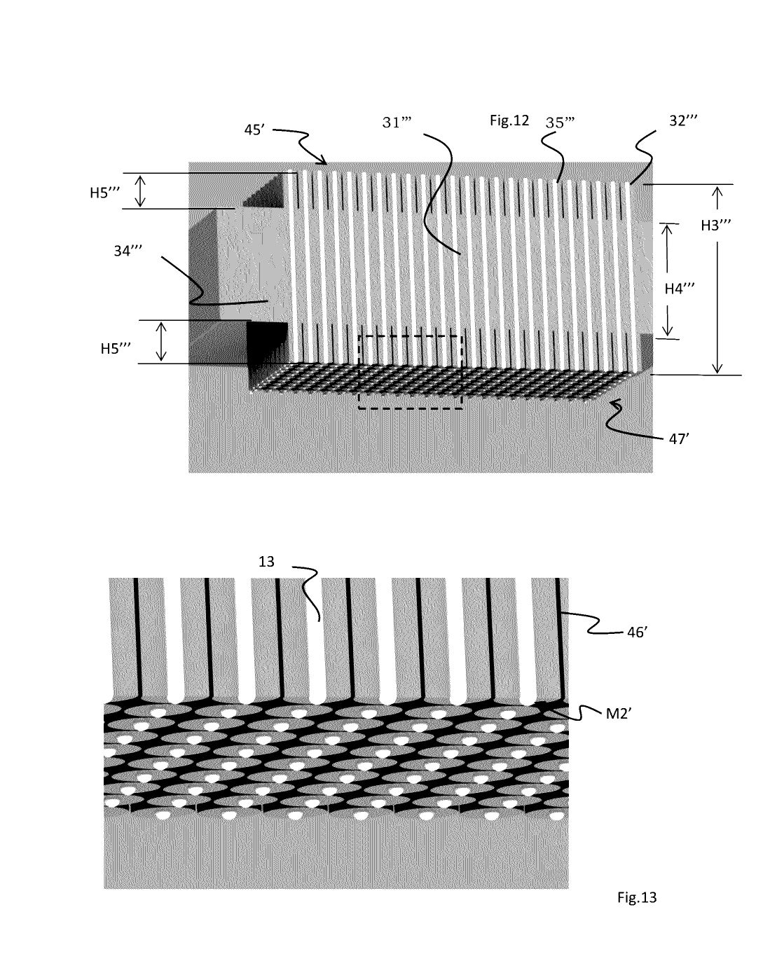

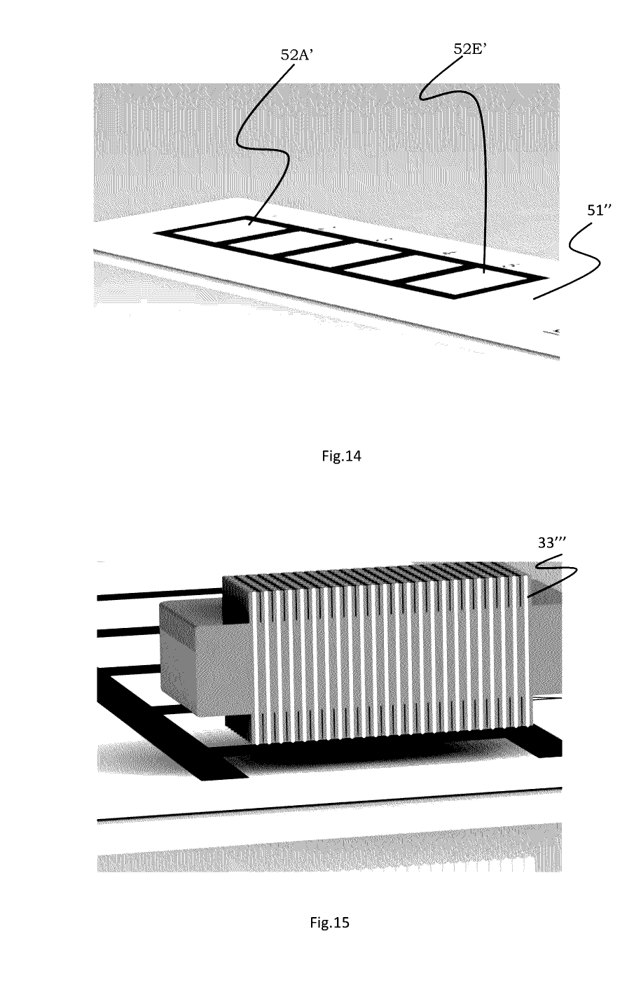

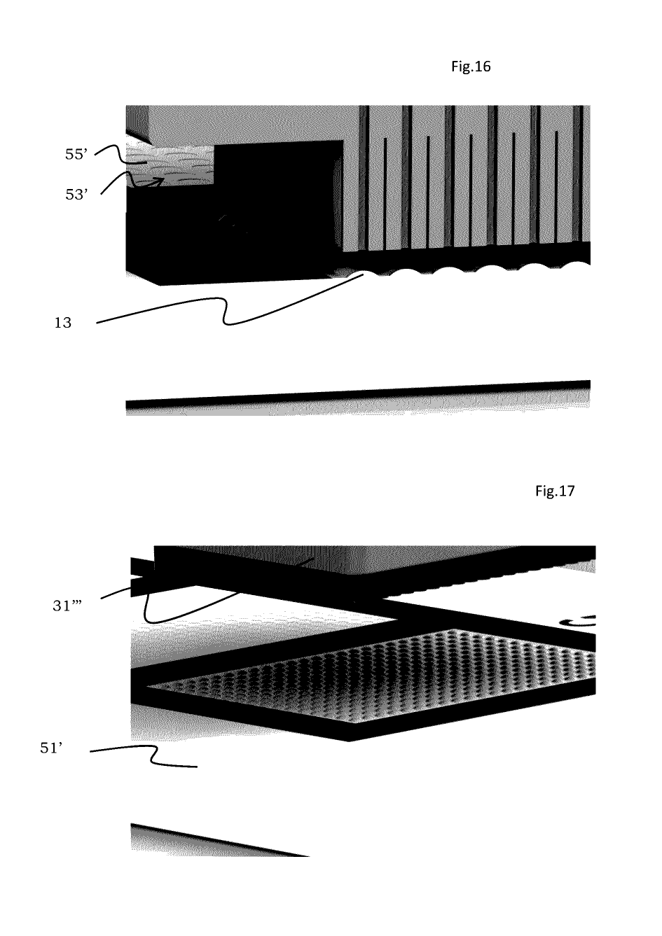

A dispensing system in accordance with another embodiment of the present invention is shown in FIGS. 5 to 17. The system comprises a manifold plate (1′) and a transfer block (31″). A slide (51′) suitable for use with the dispensing system is also shown. The manifold plate (1′) comprises a substantially quadratic substrate (3′) with an upper major surface (5′) preferably parallel to a lower major surface (7′). The upper and lower major surfaces are separated by side walls (9)' of height H1. As shown in FIGS. 6-8, the upper surface has a plurality N (e.g. N=384) of reservoirs in the form of wells (11) which extend a distance d′ into the substrate where d′ <H1′ (for example when H1′ is 14.2 mm then d′ is less than or equal to 7 mm) towards the lower major surface. The wells are shown arranged in a 24×16 well array but any shaped array is possible. Each well is openable on the upper surface in order to allow each well to be filled with an individual liquid (13′) such as a reagent. Each liquid may be different from all other liquids or some or all of the liquids may be duplicated. It is possible to provide the manifold plate with a cover in order to reduce or eliminate evaporation of liquids. The base (17′) of each well is of thickness w′ (for example 0.7 mm) and has an outlet opening (20′) which extends through the base. The base of each well opens out into a chamber (18′) of depth c′ and which has a length L6′ and a width W6′ which opens out in the underside of the substrate (3′), i.e. c′+d′+w′=H1′. The length L6′ and W6′ are adapted to be sufficiently large that every outlet opening (20′) in the base of the wells opens out into the chamber. In order to transport the liquid from each well to a capillary outlet (21′) on the lower major surface of the manifold plate each well outlet opening (20′) is in liquid connection with a respective capillary (19′) which leads to a respective capillary outlet (21′).

The capillaries (19′) are formed in a capillary stack (20′) comprising a plurality M of capillary plates (22a′-22m′) mounted inside the chamber. Each capillary plate comprises a substrate of length L7′, width W7′ and depth D7′, where L7′ is equal to or less than L6 and W7′ is less than or equal to W6′. The depth D7′ of each of the capillary plates may be chosen so that the stack of plates has a depth which is the same as the depth of the chamber c′ so that the bottom surface of the manifold plate is flush. Alternatively the depth of the plates may be chosen so that the stack of plates has a depth which is less than the depth of the chamber c′ so that the bottom surface of the outermost plate (22m′) is recessed inside the chamber and does not come into contact with any planar surface that the manifold plate is resting on. This reduces the risk of contamination of the capillary outlets (21′).

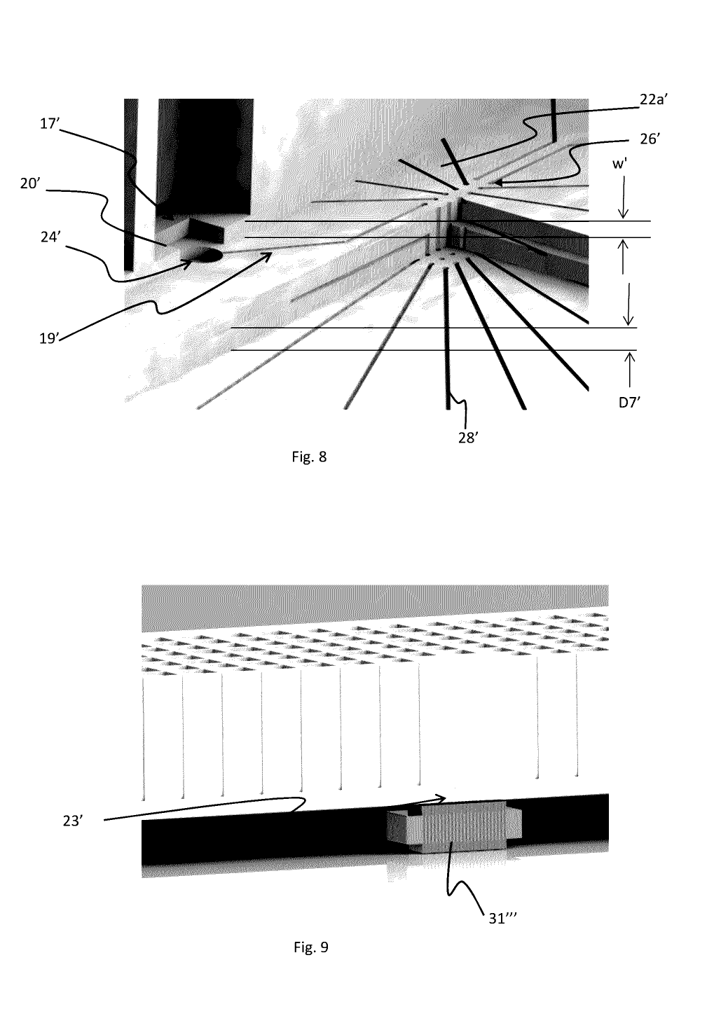

Each capillary plate (22a′ to 22m′) is intended to provide part of the vertical and horizontal paths necessary to form capillaries (19′) for transporting the liquid originating in the wells to the respective capillary outlet (21′). As shown in FIG. 8, this is achieved by providing well opening through holes (24′) in the plates in positions which match the positions of the outlet openings (20′) in each well and capillary outlet through holes (26′) in positions which match the positions of the capillary outlets formed in the outermost capillary plate (22n′). In order to avoid the problems which would arise due to manufacturing tolerances if an attempt was made to provide on a single capillary plate all of the 384 capillaries necessary to connect the 384 wells with the 384 capillary outlets, the capillaries are spaced out over the M capillary plates. For example if M=8 then each capillary plate would contain on average 48 capillaries. In this example then on each of the capillary plates (22a′ to 22m′) on average 48 of the well opening through holes (24′) are joined to their respective capillary outlet through holes (26′) by a capillary groove (28′) that can be formed in the upper or lower surface of the plate. Preferably each capillary groove has a square or rectangular cross section with a width e which preferably is equal to or greater than 10 μm and is equal to or less than 100 μm and a height f preferably is equal to or greater than 10 μm and is equal to or less than 100 μm. Other cross-sectional channel shapes are also conceivable, for example a V-shaped section, a semi-circular section, a semi-oval section, a polygonal section, etc. Preferably the plate substrate is made of an injection-mouldable polymer such as a cyclic oleo polymer or polystyrene. Each capillary groove becomes a closed capillary when the surface of the plate that it is formed in is brought into contact with an adjacent plate or the roof of the chamber.

As described above in connection with the earlier embodiment of the present invention, the 384 capillary openings are arranged in a dispensing array (23′) which in this example of the invention matches, but is much smaller than, that of the wells, i.e. an array of 24 openings by 16 openings. Each capillary opening (21′) has a diameter D2′ which preferably is equal or greater than 10 μm and is equal to or less than 100 μm. Other quadratic arrays formats are of course possible, for example, 12 by 32 or 6×64, etc. it is also possible that the array forms any other shape, for example a ring, a circle, a hexagon, a triangle, etc. In this example the quadratic dispensing array has a length L2 and width W2. Preferably the centre-to-centre (C-C) distance of the outlet ports of the micro array is equal to or less than 1 mm and more preferably is equal to or less than 500 μm and equal to or greater than 50 μm. A grid of 384 capillary openings may thus have an area of approximately 2 square centimetres or less.

FIGS. 9-13 and 15-17 include details of a further embodiment of a transfer block according to the present invention. This transfer block (31″) is formed of 384 capillary tubes (32′) of length H3′″ each with a capillary through channel (33′). The capillary tubes are arranged in an array in which the longitudinal axis of the tubes are parallel to each other and the inlets (35′) are laid out in an inlet array which matches the array of capillary through channel outlets on the manifold plate. The capillary tubes are held together by a surrounding body (34′″). Surrounding body (34′″) can be made of a polymer material which is cast or moulded around the capillary tubes. The body is of height H4′″ which is less than H3′″ and is preferably arranged symmetrically around the capillary tubes so that the inlet ends and outlet ends of the capillary tubes each extend a distance H5′″ from the surface of the surrounding body where H5′=(H3′″−H4′″)/2. This means that the transfer block is symmetrical and can be used either way up. The use of a surrounding body which has a height H4′″ which is less than the height H3′″ of the capillary tubes and which is centred on the capillary tubes ensures that the interstitial spaces (46′) between the inlet and outlet ends of the capillary tubes are unfilled and provide space for excess liquid from one inlet to accumulate without contaminating any other inlet.

In order to load a transfer block with reagents, the transfer block is positioned below and in alignment with the dispensing array of capillary through channel outlets in the lower surface of the manifold plate. When the transfer block is raised or in some other way positioned into contact with the underside of the manifold plate, each capillary through channel in the liquid inlet surface (45′), normally the upper surface, of the transfer block will come into contact with the meniscus above it and capillary force will cause the liquid (13) to flow into the capillary through channel and form a convex meniscus M2′ on the outlet (37′) of the capillary through channel on the liquid dispensing surface (47′), normally the lower surface, of the transfer block. The reagent will continue to flow into the capillary through channel until the capillary through channel is full or contact between the capillary through channel and the outlet on the manifold plate is broken.

FIGS. 14-17 show a quadratic liquid-receiving substrate in the form of a slide (51′) able to accommodate five liquid-receiving arrays (52A′-52E′), each of width W2 and length L2. Each liquid receiving array (52′) comprises 384 liquid-receiving areas (53′) laid out in an array of the same shape and size as the outlet array (43′″) on the liquid dispensing surface (47′″) of the transfer block. Preferably each liquid-receiving area intended to receive a liquid such as a reagent in aqueous solution is provided with an anchoring surface feature (55′) which helps to anchor into place any liquid which comes into contact with it. An anchoring surface feature (55′) may be a circular depression or the like. Each liquid-receiving area may also be provided with a hydrophobic surface, surface treatment or coating between the anchoring surface features to ensure that aqueous liquids do not rest there. Preferably the diameter D5′ of each anchoring surface feature is equal to or less than the outlet diameter D4′ of the corresponding outlet in the transfer block.

FIG. 18 shows schematically and not to scale a first embodiment of a dispensing system in accordance with the present invention. This system comprises a transport system (61), for example an articulated robot arm, for moving a transfer block from a filling position (F) under the manifold plate where it is in contact with the dispensing array of the manifold plate and can be filled with liquids, to a loading position (L) where it may be brought into contact with a surface onto which the liquid is to be dispensed. The surface could be on any suitable substrate. The transport system may also to arranged to acquire a fresh transfer plate from a transfer plate supply station (not shown) and further arranged to move a used transfer plate to a disposal station (not shown). A kit of parts for use in the system could comprise a manifold plate and one or more compatible transfer blocks. Any suitable substrate could be used with this kit. Another kit of parts for use with such a system could comprise a manifold plate and one or more compatible transfer blocks and a sufficient number of liquid-receiving substrates to ensure that the total volume of the liquid in the manifold plate can be received, e.g. if the volume of liquid contained in a well and micro capillary is 1000 nanolitres and the size of a droplet dispensed on a substrate is 10 nanolitres then, if each substrate comprises 5 liquid-receiving arrays, the kit could contain 20 substrates. If instead of 10 nanolitres the size of a droplet is reduced to 1 nanolitres then the kit could contain 200 substrates.

The same transport system may be used to move the substrate from a substrate supply station to a contacting position (C) adjacent to the loading position where the substrate can be contacted by a transfer block and then to a substrate delivery position (not shown) where loaded substrates can be processed further, e.g. inspected, provided with manufacturing information and/or packaged. Alternatively a separate substrate transporting system (71), shown in dashed lines may be provided.

FIG. 19 shows schematically and not to scale a second embodiment of a dispensing system in accordance with the present invention. This system comprises a transport system (61′), for example an articulated robot arm, for moving a transfer block from a filling position (F′) under the manifold plate where it is in contact with the dispensing array of the manifold plate to a loading position (L′) where it can be brought in contact with the liquid-receiving array on a slide (51) of the type described above. The transport system may also be arranged to acquire a fresh transfer plate from a transfer plate supply station (not shown) and further arranged to move a used transfer plate to a disposal station (not shown).

The same transport system may be used to move a slide from a slide supply station (not shown) to a contacting position (C′) where the slide can be contacted by a transfer block and then to a slide delivery position (not shown) where loaded slides can be processed further, e.g. inspected, provided with manufacturing information and/or packaged. Alternatively a separate slide transporting system (71′) may be provided.

A kit of parts for use in the system could comprise a manifold plate and one or more compatible transfer blocks. Any suitable substrate could be used with this kit. Another kit of parts for use with such a system could comprise a manifold plate and one or more compatible transfer blocks and a sufficient number of liquid-receiving substrates to ensure that the total volume of the liquid in the manifold plate can be received.

In order to dispense liquids to a liquid-receiving substrate, e.g. a slide, a transfer block is first loaded with liquids as described above. The transfer block can then be lowered out of contact with the manifold plate and the outlet array (43) of capillaries brought into aligned contact with an array of liquid-receiving areas on the liquid-receiving slide. Once contact is achieved between the transfer block and the liquid-receiving slide some of the liquid in each through channel in the transfer block will be transferred to the slide by capillary force. The transfer block can then be raised (or the slide lowered), breaking contact between the transfer block and the liquid-receiving slide while thus allowing some of the liquid (13) to remain on the slide in the liquid receiving areas (LRA1). Once the liquid has been transferred the next liquid-receiving array on the slide can then be contacted by the transfer block. This can be repeated until all the liquid receiving arrays on the liquid-receiving slide have been loaded with liquids. The liquid-receiving slide can be moved away for further processing.

While the liquid-receiving slide is being moved away or when the amount of liquid in the transfer block has dropped to a predetermined level in at least one of the through channels the transfer block can be reloaded. This is achieved by bringing the transfer block into contact again with the dispensing array of capillary outlets on the underside of the manifold plate. This will cause the capillaries of the transfer block to be replenished with liquids.

The incompletely loaded liquid-receiving slide or a new liquid-receiving slide can be positioned below the transfer block and loaded with liquids by lowering the transfer block as described above. This can be repeated as required.

The amount of liquid transferred to the liquid-receiving substrate will depend on the size of the through channel and the surface properties of the channel material and the liquid-receiving substrate in contact with the liquid. Provided that the same material is used for every liquid-receiving substrate then the volume dispensed from a given transfer block transporting a given set of liquids will be consistent and precise. Preferably the quantity of liquid transferred will be equal to or less than 10 nano-litres, more preferably equal to or less than 5 nano-litres and most preferably equal to or less than 1 nano-litre. Preferably the system is provided with a transfer means such as a robot which is adapted to move a transfer block between the dispensing position where it is in contact with a liquid-receiving slide to the loading position where it is in contact with the manifold plate in a period of time which is equal to or less than five seconds. In order to reduce losses due to evaporation of liquids from the open ends of the capillaries in the transfer block the system should maintain the transfer block in contact with the liquid-receiving slide for a transfer time which is equal to or less than 5 seconds, more preferably equal to or less than 3 seconds and most preferably equal to or less than 1 second.

Another method for reducing the undesired evaporation of reagent is to provide an enclosure, for example a room or housing, around the system in which the humidity is maintained high.

A method for loading liquid on to a liquid-receiving substrate in accordance with one embodiment of the present invention includes the following process steps:

a) fill each desired well in a manifold plate with the desired liquid.

b) optionally inspect the manifold plate to confirm that the manifold plate presents all the liquids in the outlet capillaries on the underside of the manifold plate.

c) present the array of inlets to the capillary through channels on the transfer block to the outlet capillaries of the manifold plate for a period of time long enough for the capillary through channels to be filled.

d) move the transfer block away from the manifold plate.

e) optionally inspect the transfer block to confirm that the transfer block presents all the liquids in the array on the dispensing surface of the transfer block.

f) align and contact the array of outlets on the liquid dispensing surface with a array of liquid-receiving areas on the liquid-receiving substrate. Repeat until all the arrays of liquid receiving areas on the liquid-receiving slide have been contacted or until the liquid in one of the capillary through channels has been exhausted.

g) move the transfer block away from the liquid-receiving slide or move the liquid-receiving slide away from the transfer block.

Refilling of the capillary through channels takes place when the liquid in a capillary through channel is exhausted (which can be seen by the absence of the liquid in the capillary through tube or on a liquid-receiving area) or nearing exhaustion which can be estimated by knowing the volume of each dispensed drop and the total volume of the capillary through tube.

Once the method for loading liquid on to a liquid-receiving slide has been completed and the liquid-receiving slide has been completely loaded, the liquid-receiving slide can be inspected to confirm that all the liquid-receiving areas have been loaded as desired.

The above procedure can be repeated on all slides in the production batch, the transfer block being refilled with liquids whenever one capillary tube becomes empty or whenever it is determined that one or more of the capillary tubes is nearly empty. Preferably the transfer block and slide are moved by automated machinery such as robots.

The present invention is not limited to any specific shape or size of manifold plate, transfer block or slide - they merely need to be such that the transfer of liquid between them is possible. These may be quadratic, round, polygonal or any other shape. Furthermore they do not need to be flat - the only requirement is that they have complementary shapes and dimensions in the regions where the transfer of liquid is to take place so that transfer of the liquid is facilitated.

It is conceivable to provide manifold plates in which each well has two or more capillary outlets. These capillary outlets could be placed in the one and the same array on the lower surface of the manifold plate in order to provide duplicate sources of the reagent to the transfer block and slide. Alternatively the capillary outlets could be arranged in two or more separate, preferably spaced apart, arrays on the lower side of the manifold plate. The matching transfer block would have an equal number of matching arrays of through channels. The matching slide would either have one array of surface features which matches one array of through channels so that a plurality of slides could be loaded with reagents in parallel, or a slide could have a plurality of arrays which could be loaded with reagents simultaneously. This could be useful if a slide is only intended to accommodate, for example, 96 different reagents. In such a case a slide could have one array of 96 surface features and a plurality of, e.g. four, slides could be loaded at the same time. Alternatively a slide could have four arrays, each with 96 surface features, and this single slide could be loaded with four arrays of reagents. Such a slide could then be divided into four to provide four separate test slides.

Analogously a transfer plate may be provided with more inlets than outlets, so that each outlet is connected to a plurality of inlets, or it could be provided with more outlets than inlets, wherein each inlet is connected to a plurality of outlets.

While the invention has been illustrated by an example in which the reservoirs are in the form of wells, it is conceivable that a reservoir may be any shape or size and could, for example be in the form of a network or coil of tubes or capillaries, or a chamber, or a removable container connectable to the inlet of a capillary.

1. A system for transferring one or more liquids from a reservoir to a substrate comprising:
a manifold plate with one or more liquid reservoirs wherein each reservoir is connected via one or more capillaries to an outlet surface where each capillary has an outlet and wherein the outlets are formed in a dispensing array on said outlet surface;
a transfer block with a first, liquid-receiving surface and a second, liquid dispensing surface, wherein the transfer block comprises capillary through channels running from the liquid receiving surface to the liquid-dispensing surface wherein each of the capillary through channels have an inlet on the liquid-receiving surface and said inlets form an inlet array which matches the size and shape of the dispensing array of outlets on the manifold plate, and wherein each of the capillary through channels has an outlet on the liquid-dispensing surface and said outlets form a dispensing array, and a transport device for bringing the outlet ports on said outlet surface of the manifold plate into contact with the inlets on said liquid-receiving surface of the transfer block.

2. A system according to claim 1, further comprising a liquid-receiving substrate with a surface for receiving liquid comprising liquid-receiving areas in a liquid-receiving array of the same shape and size as the outlet array on the liquid dispensing surface of the transfer block, and a transport device for bringing the dispensing array of the transfer block into contact with the array of liquid-receiving areas on the liquid-receiving substrate.

3. A system according to claim 1 wherein the diameter of the outlets on the dispensing array is equal to or greater than 10 μm and less than or equal to 100 μm.

4. A kit comprising:
a manifold plate with one or more liquid reservoirs wherein each reservoir is connected via one or more capillaries to an outlet surface where each capillary has an outlet port and wherein the outlet ports are formed in an array on said outlet surface; and,
a transfer block with a first, liquid-receiving surface and a second, liquid dispensing surface, wherein the transfer block comprises channels running from the liquid receiving surface to the liquid-dispensing surface wherein each of the channels have an inlet on the liquid-receiving surface and said inlets form an array which matches the size and shape of the array of outlet ports on the manifold plate, and wherein each of the channels has an outlet on the liquid-dispensing surface and said outlets form a dispensing array.

5. The kit according to claim 4, further comprising:
a liquid-receiving substrate with a surface for receiving liquid comprising liquid-receiving areas in a liquid-receiving array of the same shape and size as the outlet array on the liquid dispensing surface of the transfer block.

6. A transfer block comprising a liquid-receiving surface and a liquid dispensing surface, wherein the transfer block comprises capillary through channels running from the liquid receiving surface to the liquid-dispensing surface wherein each of the capillary through channels has an inlet on the liquid-receiving surface and said inlets form an inlet array which matches the size and shape of the dispensing array of capillary outlets on the manifold plate, and wherein each of the capillary through channels has an outlet on the liquid-dispensing surface and said outlets form an outlet array.

7. A transfer block according to claim 6 wherein the surface of the second, liquid-dispensing surface between the outlets of the capillary through channels is hydrophobic.

8. A transfer block according to claim 6 wherein the diameter of an outlet is greater than the diameter of a channel.

9. The system of claim 1. further comprising a substrate having a plurality of liquid-receiving areas arranged in a liquid-receiving array.

10. A system according to claim 9 wherein the substrate comprises a plurality of liquid-receiving arrays.

11. A method of transferring individual droplets of liquid to a substrate surface using a system according to comprising:
a. providing a system for transferring one or more liquids from a reservoir to a substrate comprising:
a manifold plate with one or more liquid reservoirs wherein each reservoir is connected via one or more capillaries to an outlet surface where each capillary has an outlet and wherein the outlets are formed in a dispensing array on said outlet surface;
a transfer block with a first, liquid-receiving surface and a second, liquid dispensing surface, wherein the transfer block comprises capillary through channels running from the liquid receiving surface to the liquid-dispensing surface wherein each of the capillary through channels have an inlet on the liquid-receiving surface and said inlets form an inlet array which matches the size and shape of the dispensing array of outlets on the manifold plate, and wherein each of the capillary through channels has an outlet on the liquid-dispensing surface and said outlets form a dispensing array, and
a transport device for bringing the outlet ports on said outlet surface of the manifold plate into contact with the inlets on said liquid-receiving surface of the transfer block;
b. providing a liquid-receiving substrate;
c. supplying at least one liquid to the reservoirs of the manifold plate;
d. transferring the at least one liquid to the outlets of the dispensing array of the transfer block by contacting the capillary outlets on the manifold plate to the capillary inlets on the transport block to allow the liquid to enter the capillary through channels by capillary action; and
e. placing the liquid receiving surface of the substrate in contact with the dispensing array of the transfer block.
